(19) United States
(12) Patent Application Publication
(10) Pub. No.: US 2011/0051395 A1
(43) Pub. Date: Mar. 3, 2011

(54) SIGNAGE

(75) Inventor: David Field, Elsternwick (AU)

(73) Assignee: Major Media Pty Ltd, Kensington (AU)

(21) Appl. No.: 12/745,387

(22) PCT Filed: Nov. 28, 2008
(86) PCT No.: PCT/AU2008/001758

§ 371 Date: Oct. 26, 2010

(30) Foreign Application Priority Data
Nov. 29, 2007 (AU) 2007906533

(51) Int. Cl. F21V 9/16; F21V 7/00; F21V 9/00; F21V 11/00

(52) U.S. Cl. 362/84; 362/296.01; 362/235; 362/231; 362/257

(57) ABSTRACT

This invention concerns a media display sign (10) that is illuminable. The sign comprises with an illuminable portion that has an outline shape that includes straight line segments interposed by corners and/or includes curves and has a light transmission wall (18′) with a shape that corresponds generally to the shape of the illuminated portion. The sign also comprises a source of illumination (26) arranged to follow closely the shape of the light transmission wall (18′). The sign (10) also comprises a light reflective apparatus (34) associated with illuminable portion for reflecting light from the source of illumination (26) outwardly via the first side (12) to illuminate the illuminable portion.

### FIELD OF THE INVENTION

The present invention relates to signage and, particularly, to signage including lighting for illuminating the signage.

### BACKGROUND OF THE INVENTION

Conventional methods of illuminating signage include placing lighting behind transparent or translucent materials (so-called “rear-lit” or “back-lit”) or along an edge of the material (so-called “edge-lit”).

Edge-lit displays are characterized by a large square or rectangular panel shape with fluorescent, neon or light emitting diode (LED) lighting disposed along the edges of the square or rectangle. As a result, illumination of central regions of the display is less than perimeter regions in closer proximity to the lighting.

Furthermore, such edge-lit displays are unsuitable for illuminating only selected sections of a panel. For example, providing relatively even illumination of text without illuminating areas surrounding the text is not economically feasible.

Selective illumination of text can be achieved with back-lit displays. However, even illumination is a problem.

Specifically, if a display to be illuminated is placed too closely to a light source, the display appears brighter in areas closer to the light source and darker in areas that are spaced further away. Even illumination is typically achieved by spacing the display from a light source by a distance that allows adequate light dispersion.

Accordingly, back-lit displays are typically built as light boxes and have a considerable depth aspect to allow adequate spacing of the light source and the material.

### SUMMARY OF THE INVENTION

An object of the invention is to provide more compact illuminated signs than signs formed according to conventional edge-lit and back-lit forms.

Advantageously, the invention may provide improved illumination evenness.

The invention provides a sign for illumination by a source of illumination, the sign comprising:
(a) a light transfer apparatus having an illuminable portion with spaced apart opposed first and second sides, the illuminable portion having an outline shape that includes straight line segments interposed by corners and/or includes curves and having a light transmission wall with a shape that corresponds generally to the shape of the illuminable portion and that is located at least part way between the first and second sides;
(b) a source of illumination arranged to follow closely the shape of the light transmission wall along at least part of the wall and is arranged to direct light into the light transfer apparatus in a direction generally parallel to the first and second sides; and
(c) a light reflective apparatus associated with the second side for reflecting light from the source of illumination outwardly via the first side, thereby causing illumination of the illuminable portion.

Arranging a light source to follow a shaped outline of a portion of a display that is to be illuminated brings the source of illumination closer to the portion. This has a significant impact on the size of signs because shaping the light source to follow the shape of the illuminable portion enables the sign to be formed in the shape of the illuminable portion, rather than a large square or rectangular panel. Furthermore, providing illumination via an edge of the portion to be illuminated enables the spacing between the front of the sign and the source of illumination to be considerably reduced compared with back-lit signs.

Shaping the light source to follow the shaped outline of a display, in combination with a reflective medium on the rear side of the display, improves evenness of illumination because illumination of the sign is not reliant upon light travelling directly from the source of illumination outwardly from the sign.

Preferably, the light transfer apparatus of the sign is solid.

With a solid light transfer apparatus, light from the source of illumination will be subject to some internal reflection from an interface at the first and second sides. The reflected light travels through the light transfer apparatus away from the light source until it reflects off the light reflective apparatus and is transmitted outwardly via the first side. In this manner the internal reflection improves evenness of illumination in an area close to the light source and improves illumination in areas away from the light source. The overall result is improved evenness of illumination across the sign.

Preferably, the shape of the light transmission wall corresponds substantially to the outline shape of the illuminable portion.

Preferably, the shape of the light transmission wall corresponds to the outline shape of the illuminable portion.

The light transfer apparatus has a perimeter wall extending between the first and second sides and the light transmission wall may comprise the perimeter wall.

Preferably, the light transfer apparatus includes a channel for receiving the source of illumination and that closely follows the perimeter wall to define an inbound region of the light transfer apparatus, and wherein an interface between the channel and the inbound region comprises the light transmission wall.

Preferably, the channel is located adjacent to the perimeter wall and closely follows the perimeter wall to define an inbound region and an outbound perimeter region between the channel and the perimeter wall and wherein an interface between the channel and the inbound region comprises the light transmission wall.

In one embodiment, the source of illumination may be arranged to direct light into the inbound region and the outbound region and wherein interfaces between the channel and the respective inbound and outbound regions comprise light transmission walls.

Preferably, the channel is formed to receive the source of illumination.

Preferably, the source of illumination comprises a plurality of lighting elements disposed at regular intervals along a strip.

Preferably, the strip is flexible so the strip is locatable within the channel to conform with at least a segment of the channel shape that includes a corner and/or curve.

Preferably, the lighting elements are light emitting diodes.

Preferably, the light emitting diodes are able to produce multiple colours of light to illuminate the sign in a corresponding colour.

Preferably, the light reflective apparatus associated with the second side comprises a material which, when placed in contact with the second side, substantially excludes air at an interface between the material and the second side so that light passing through the second side is reflected back into the light transfer apparatus.

Preferably, the light reflective apparatus is selected from the following group: a layer of paint, self-adhesive materials, including vinyl film, and a material with a film of a liquid disposed between the material and the second side.

Preferably, the light transfer apparatus has an outline shape corresponding to the shape of an indicium, such as a letter, number, symbol or figure, and the outline shape includes straight line segments interposed with corners and/or includes curves.

Preferably, the light transfer apparatus is formed of transparent and/or translucent material.

Preferably, the sign includes a diffuser located over the first side for dispersing light emitted from the first side.

The diffuser operates to improve even dispersion of light from the sign.

Preferably, the diffuser is fixed to the light transfer apparatus.

Preferably, the diffuser comprises a translucent material.

The translucent material may be colored or may be coated with translucent colored members, such as colored vinyl sheet or vinyl sheet carrying a printed image.

The sign my be made to any thickness greater than 5 mm. Preferably, the sign has a thickness in the range of 5 to 80 mm.

The invention provides a sign for illumination by a source of illumination, the sign comprising:
(a) a light dispersion apparatus having a outline shape defined by a shaped perimeter wall;
(b) a source of illumination arranged to transmit light into the light dispersion apparatus via the shaped perimeter wall, whereby the light dispersion apparatus is illuminable by the source of illumination; and
   wherein the sign has a thickness in the range of 5 to 80 mm.

Preferably, the sign has a thickness less than 40 mm.

Preferably, the sign has a thickness less than 20 mm.

### BRIEF DESCRIPTION OF THE DRAWINGS

Embodiments of the invention will now be described, by way of example only, with reference to the accompanying drawings, in which:

FIG. 1 is a front perspective cut-away view of a sign in accordance with an embodiment of the invention.

FIG. 2 is a cross-section along the line II-II in FIG. 1.

### DETAILED DESCRIPTION OF EMBODIMENTS

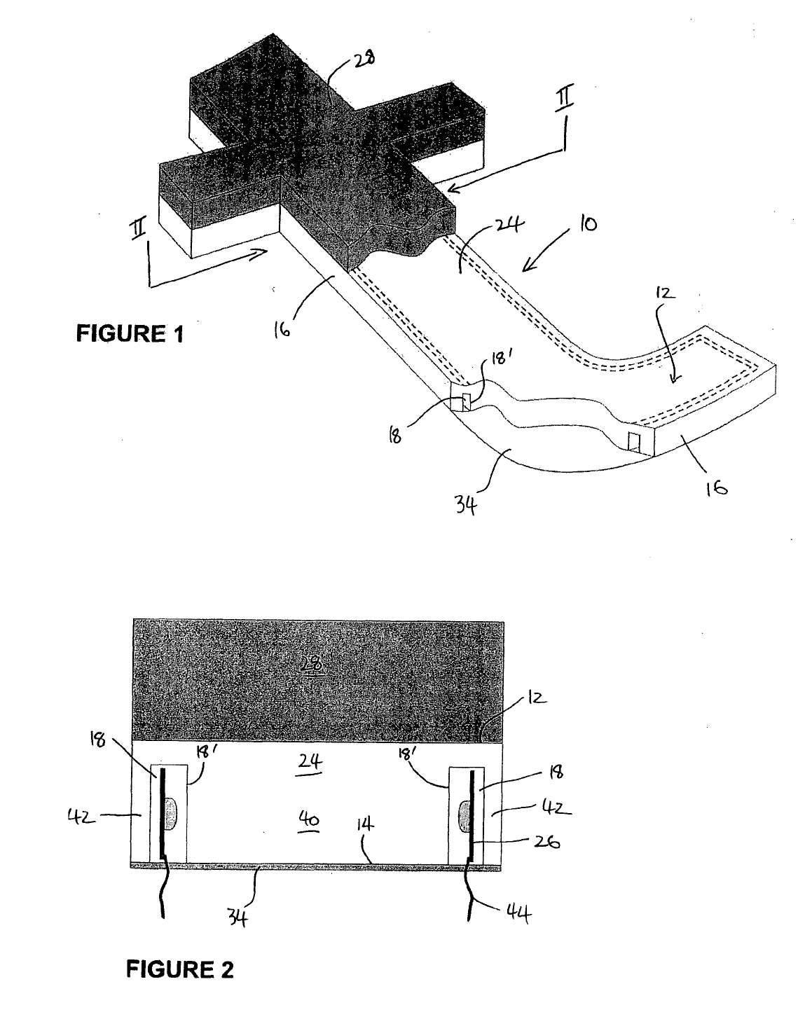

A sign 10 in accordance with an embodiment of the invention is shown in FIGS. 1 and 2.

The sign 10 comprises a light transfer apparatus, in the form of transparent acrylic 24. The acrylic 24 has first and second sides in the form of front and rear surfaces 12 and 14 and a perimeter comprising a shaped edge wall 16 that defines the shape of the acrylic 24.

The sign further comprises a light reflective apparatus in the form of a vinyl layer 34 disposed on a rear surface 14 of the acrylic 24 to reflect light incident upon the rear surface 14 back into the acrylic 24 and, typically, out the front surface 12.

The sign further includes a diffuser in the form of a translucent acrylic layer 28. The acrylic layer 28 disperses incident light from the acrylic 24 outwardly from the sign 10. The translucent acrylic layer 28 has the effect of reducing contrast between areas of bright light and areas of less bright light so the overall illumination effect is to provide relatively even illumination from the sign.

Although not shown in FIGS. 1 and 2, the acrylic layer 28 may be covered with a translucent or transparent vinyl film that is colored or on which images are printed.

The acrylic layer 24 includes a channel 18 formed in the rear side 14 for receiving a source of illumination. The channel 18 is formed adjacently to the perimeter wall 16 and defines a boundary between an inboard region 40 and an outboard region 42. The channel follows closely the shape of the perimeter wall 16 and so is shaped correspondingly to the perimeter wall 16. The specific shape of the channel 18 in the acrylic 24 is marked with dotted line in FIG. 1.

The sign 10 includes a source of illumination in the form of a flexible strip of LEDs 26 (FIG. 2). The strip 26 comprises a substrate ribbon of including electrical conductor to which is mounted a series of LEDs at regular intervals. The strip 26 is located in the channel 18 and is arranged so that the LEDs direct light through a light transmission wall in the form of an interface 18′ between the channel 18 and the acrylic 24.

Although shown directing light into the inboard region 40 of the acrylic 24, the strip 26 may be arranged to direct light into the outboard regions 42 or into both the inboard and outboard regions 40 and 42.

In some circumstances, the inboard region 40 is too wide to achieve suitable even illumination from lighting disposed in the channel 18. The circumstances, however, depend on a number of factors, including the coloring of any layers over the first side 12, spacing between the channels 18, the normal brightness of LEDs on the strip and the intended brightness in the inboard region. Generally, the applicant recognises that a central channel located between the channels 18 may be required for two additional strips 26 in a back-to-back configuration. The central channel is parallel to the adjacent channels 18 and hence will have a shape that corresponds to the outline shape of the sign 10. Accordingly, the central channel includes strips 26 shaped to conform to the shape of the sign 10.

It should also be appreciated that in some circumstances, the channels 18 may be omitted in place of a central channel only with strips 26 arranged to direct light outwardly toward the perimeter wall of the acrylic 24.

The vinyl layer 34 is disposed on the rear side 14 and assists to retain the strip 26 in the channel 18.

Electrical conduits 44 are used to link the strips 26 to a source of electrical energy for illumination the sign 10.

In one embodiment, the support apparatus may comprise a building wall with stand-off arms so that the sign 10 is spaced from the wall when mounted to the stand-off arms. In this embodiment, the sign 10 may be configured to allow light to emit from the rear side 14 to provide a halo illumination effect on the building wall. In such an embodiment, the vinyl layer 34 is formed to be translucent, but still with reflective properties to allow some light to move through the vinyl layer 34 onto the building wall and to reflect some light back into the acrylic 24.

It will be appreciated that the width of the strip 26 has a large impact on the overall thickness of the sign 10. The strip 26 may have a width of 4 mm or less. In such circumstances, the applicant recognises that illuminated signs may be formed with an overall thickness of at least 5 mm and anticipates signs having a thickness in the range of 5 to 80 mm, and, particularly, less than 40 mm in thickness and, more particularly, less than 20 mm in thickness. However, signs with a thickness greater than 80 mm may be formed, for example with the acrylic 28 spaced from the front side 12.

Many modifications may be made to the preferred embodiment of the present invention as described above without departing from the spirit and scope of the present invention.

It will be understood that the term “comprises” or its grammatical variants as used in this specification and claims is equivalent to the term “includes” and is not to be taken as excluding the presence of other features or elements.

1. An illumination apparatus comprising:
a light transfer apparatus having an illuminable portion with spaced apart opposed first and second sides, the illuminable portion having an outline shape that includes straight line segments interposed by corners and/or includes curves and having a light transmission wall with a shape that corresponds generally to the shape of the illuminated portion and that is located at least part way between the first and second sides;
a source of illumination arranged to follow the shape of the light transmission wall along at least part of the wall and is arranged to direct light into the light transfer apparatus in a direction generally parallel to the first and second sides; and
a light reflective apparatus associated with the second side for reflecting light from the source of illumination outwardly via the first side, thereby causing illumination of the illuminable portion.

2. The illumination apparatus of claim 1, wherein the light transfer apparatus of is solid.

3. The illumination apparatus of claim 2, wherein the shape of the light transmission wall corresponds substantially to the outline shape of the illuminable portion.

4. The illumination apparatus of claim 2, wherein the shape of the light transmission wall corresponds to the outline shape of the illuminable portion.

5. The illumination apparatus of claim 3, wherein the light transfer apparatus has a perimeter wall extending between the first and second sides and the light transmission wall comprises the perimeter wall.

6. The illumination apparatus of claim 5, wherein the light transfer apparatus includes a channel for receiving the source of illumination and that follows the perimeter wall to define an inbound region of the light transfer apparatus, and wherein an interface between the channel and the inbound region comprises the light transmission wall.

7. The illumination apparatus of claim 5, wherein the light transfer apparatus includes a channel located adjacent to the perimeter wall and which follows the perimeter wall to define an inbound region and an outbound perimeter region between the channel and the perimeter wall and wherein an interface between the channel and the inbound region comprises the light transmission wall.

8. The illumination apparatus of claim 7, wherein the source of illumination is arranged to direct light into the inbound region and the outbound region and wherein interfaces between the channel and the respective inbound and outbound regions comprise light transmission walls.

9. The illumination apparatus of claim 1, wherein the source of illumination comprises a plurality of lighting elements disposed at regular intervals along a strip.

10. The illumination apparatus of claim 9, wherein the strip is flexible so the strip is locatable within the channel to conform with at least a segment of the channel shape that includes at least one of a corner and a curve.

11. The illumination apparatus of claim 10, wherein the lighting elements are light emitting diodes.

12. The illumination apparatus of claim 11, wherein the light emitting diodes are able to produce multiple colors of light to illuminate at least a portion of the illumination apparatus in a selected color.

13. The illumination apparatus of claim 1, wherein the light reflective apparatus associated with the second side comprises a material which, when placed in contact with the second side, substantially excludes air at an interface between the material and the second side so that light passing through the second side is reflected back into the light transfer apparatus.

14. The illumination apparatus of claim 13, wherein the light reflective apparatus is selected from the following group: a layer of paint, self-adhesive materials, including vinyl film, and a material with a film of a liquid disposed between the material and the second side.

15. The illumination apparatus of claim 1, wherein the light transfer apparatus has an outline shape corresponding to the shape of an indicium and the outline shape includes straight line segments interposed with corners and/or includes curves.

16. The illumination apparatus of claim 1, wherein the light transfer apparatus is formed of at least one of a transparent material and a translucent material.

17. The illumination apparatus of claim 1, further comprising a diffuser located over the first side for dispersing light emitted from the first side.

18. The illumination apparatus of claim 17, wherein the diffuser is fixed to the light transfer apparatus.

19. The illumination apparatus of claim 17, wherein the diffuser comprises a translucent material.

20. The illumination apparatus of claim 19, wherein the translucent material is colored or is coated with one or more colored vinyl sheets.

21. The illumination apparatus of claim 1, further comprising fastening members for fastening at least one of the light transfer apparatus, the source of illumination, and the light reflective apparatus to a support apparatus.

22. The illumination apparatus of claim 1, wherein the illumination apparatus has a thickness in the range of 5 to 80 mm.

23. An illumination apparatus comprising:
a light dispersion apparatus having a outline shape defined by a shaped perimeter wall;
a source of illumination arranged to transmit light into the light dispersion apparatus via the shaped perimeter wall, whereby the light dispersion apparatus is illuminable by the source of illumination; and
wherein the illumination apparatus has a thickness in the range of 5 to 80 mm.

24. The illumination apparatus of claim 23, wherein the illumination apparatus has a thickness less than 40 mm.

25. The illumination apparatus of claim 23, wherein the illumination apparatus has a thickness less than 20 mm.
